(19) United States
(12) Patent Application Publication
(10) Pub. No.: US 2025/0247509 A1
(43) Pub. Date: Jul. 31, 2025

(54) CORRECTION METHOD, SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventors: Kota TAKEUCHI, Azumino-shi (JP); Kosuke SAKU, Matsumoto-shi (JP)

(73) Assignee: SEIKO EPSON CORPORATION, Tokyo (JP)

(21) Appl. No.: 19/037,695

(22) Filed: Jan. 27, 2025

(30) Foreign Application Priority Data
Jan. 26, 2024 (JP) 2024-009978

(51) Int. Cl. H04N 9/31; G06V 10/60

(52) U.S. Cl. CPC H04N 9/3185; G06V 10/60

(57) ABSTRACT

A correction method includes acquiring a first captured image obtained by imaging of a projection image and a planar surface in a first period, acquiring a second captured image obtained by imaging of the projection image and the planar surface in a second period after the first period, extracting a first feature point and a second feature point of the planar surface in the first captured image, extracting a third feature point corresponding to the first feature point and a fourth feature point corresponding to the second feature point of the planar surface in the second captured image, calculating a first normal vector of the planar surface in the first period, calculating a second normal vector of the planar surface in the second period, and correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.

The present application is based on, and claims priority from JP Application Serial Number 2024-009978, filed Jan. 26, 2024, the disclosure of which is hereby incorporated by reference herein in its entirety.

### BACKGROUND

### 1. Technical Field

The present disclosure relates to a correction method, a system, and a non-transitory computer-readable storage medium storing a program.

### 2. Related Art

For example, JP-A-2022-092169 discloses a projector that derives a projective transformation parameter based on four or more first feature points extracted in a first captured image captured in a first period and four or more second feature points extracted in a second captured image captured in a second period. The projective transformation parameter is used to derive a panel conversion parameter as a transformation matrix for returning the positional relationship between the projection surface and the projection image to the initial positional relationship before the apparatus main body moves, for example, in the first period.

JP-A-2022-092169 is an example of the related art.

In JP-A 2022-092169, even when the projection surface is a flat surface, four or more first feature points and four or more second feature points are required for derivation of the projective transformation parameter, however, it may be difficult to find four feature points depending on the presence of an obstacle, the angle of view of an imaging device, and the screen shape, or the like.

### SUMMARY

A correction method according to an aspect of the present disclosure is a correction method for correcting a projection image projected on a planar surface by a projector, including acquiring a first captured image obtained by imaging of the projection image and the planar surface by an imaging device in a first period, acquiring a second captured image obtained by imaging of the projection image and the planar surface by the imaging device in a second period after the first period, extracting a first feature point and a second feature point of the planar surface in the first captured image, extracting a third feature point corresponding to the first feature point and a fourth feature point corresponding to the second feature point of the planar surface in the second captured image, calculating a first normal vector as a normal vector of the planar surface in the first period, calculating a second normal vector as a normal vector of the planar surface in the second period, and correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.

A system according to an aspect of the present disclosure is a system including a projector projecting a projection image onto a planar surface, and an imaging device imaging the planar surface and the projection image, wherein the projector executes acquiring a first captured image obtained by imaging of the projection image and the planar surface by the imaging device in a first period, acquiring a second captured image obtained by imaging of the projection image and the planar surface by the imaging device in a second period after the first period, extracting a first feature point and a second feature point of the planar surface in the first captured image, extracting a third feature point corresponding to the first feature point and a fourth feature point corresponding to the second feature point of the planar surface in the second captured image, calculating a first normal vector as a normal vector of the planar surface in the first period, calculating a second normal vector as a normal vector of the planar surface in the second period, and correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.

A non-transitory computer-readable storage medium storing a program according to an aspect of the present disclosure is a non-transitory computer-readable storage medium storing a program for correcting a projection image projected onto a planar surface by a projector, the program causing a computer to execute acquiring a first captured image obtained by imaging of the projection image and the planar surface by an imaging device in a first period, acquiring a second captured image obtained by imaging of the projection image and the planar surface by the imaging device in a second period after the first period, extracting a first feature point and a second feature point of the planar surface in the first captured image, extracting a third feature point corresponding to the first feature point and a fourth feature point corresponding to the second feature point of the planar surface in the second captured image, calculating a first normal vector as a normal vector of the planar surface in the first period, calculating a second normal vector as a normal vector of the planar surface in the second period, and correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.

### BRIEF DESCRIPTION OF THE DRAWINGS

FIG. 1 shows an overview of a system used for a correction method according to an embodiment.

FIG. 2 is a block diagram of a projector used in the system according to the embodiment.

FIG. 3 is a flowchart showing a flow of the correction method according to the embodiment.

FIG. 4 shows acquisition of a first captured image.

FIG. 5 shows the first captured image.

FIG. 6 shows acquisition of a second captured image.

FIG. 7 shows the second captured image.

FIG. 8 shows a relationship among a first feature point, a second feature point, a third feature point, and a fourth feature point.

FIG. 9 shows correction of a position of a projection image.

### DESCRIPTION OF EMBODIMENTS

As below, preferred embodiments according to the present disclosure will be explained with reference to the accompanying drawings. In the drawings, dimensions and scales of the respective parts are different from real ones as appropriate and some parts are schematically shown to facilitate understanding. The scope of the present disclosure is not limited to the embodiments unless otherwise specified in the following description.

### 1. FIRST EMBODIMENT

### 1-1. Overview of System

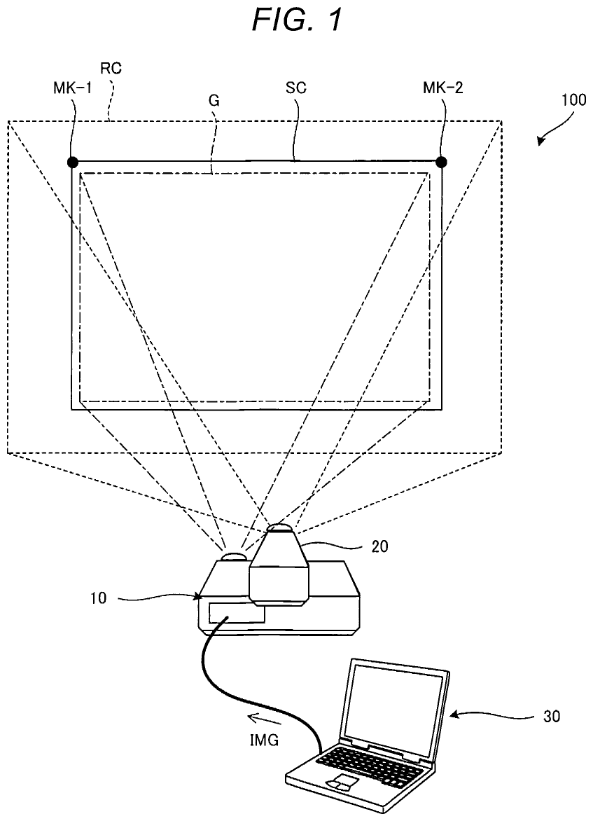

FIG. 1 shows an overview of a system 100 used for a correction method according to the embodiment. The system 100 is a projection system that projects a projection image G onto a projection surface SC.

The projection surface SC is an example of “planar surface” and includes, for example, a surface of an object such as a screen. In the example shown in FIG. 1, the outer shape of the projection surface SC is a rectangular shape. The outer shape of the projection surface SC is not limited to the example shown in FIG. 1, but may be optional. Further, the projection surface SC is not limited to a strictly planar surface, and may be a surface that is slightly curved or distorted to such an extent that the projection surface SC can be roughly regarded as a planar surface.

In the embodiment, a first physical marker MK-1 and a second physical marker MK-2 are detachably disposed in positions corresponding to two adjacent corners of the four corners of the projection surface SC. Each of the first physical marker MK-1 and the second physical marker MK-2 is a mark having different reflectance from the projection surface SC or the background of the projection surface SC and is, for example, a sticker having a different color of the projection surface SC or the background of the projection surface SC. The first physical marker MK-1 is used for extraction of a first feature point P1 and a third feature point P3, which will be described later. On the other hand, the second physical marker MK-2 is used for extraction of a second feature point P2 and a fourth feature point P4, which will be described later.

The first physical marker MK-1 and the second physical marker MK-2 are not limited to the forms detachably disposed on the projection surface SC, and may be fixedly disposed on the projection surface SC. The first physical marker MK-1 and the second physical marker MK-2 may be provided as necessary or may be omitted. In this case, instead of the first physical marker MK-1 and the second physical marker MK-2, two corners of the projection surface SC are used for extraction of the first feature point P1, the second feature point P2, the third feature point P3, and the fourth feature point P4 to be described later.

As shown in FIG. 1, the system 100 includes a projector 10, an imaging device 20, and a terminal device 30.

The projector 10 is a display apparatus that projects a projection image G represented by image data IMG output from the terminal device 30 onto the projection surface SC. In the example shown in FIG. 1, the projection image G is projected onto a rectangular area over substantially the entire projection surface SC. Here, the projection image G is disposed in the projection surface SC, and four corners of the projection image G are arranged near the four corners of the projection surface SC. Note that the projection position and the shape of the projection image G1 with respect to the projection surface SC is not limited to the example shown in FIG. 1, but may be optional. However, when the two corners of the projection surface SC are used for extraction of the first feature point P1, the second feature point P2, the third feature point P3, and the fourth feature point P4 to be described later in place of the first physical marker MK-1 and the second physical marker MK-2, it is preferable that the two corners located at both ends of one side of the projection image G are arranged near the two corners located at both ends of the corresponding one side of the projection surface SC.

The projector 10 of the embodiment has a function of controlling the operation of the imaging device 20 and a function of correcting the projection position and the shape of the projection image G using the imaging result of the imaging device 20.

The imaging device 20 is a digital camera having an imaging device such as a CCD (charge coupled device) or a CMOS (Complementary Metal Oxide Semiconductor).

The imaging device 20 images a region RC. The region RC is a region including the projection image G projected onto the projection surface SC. Accordingly, the imaging device 20 images the projection surface SC and the projection image G. The imaging device 20 may be a component element of the projector 10.

The terminal device 30 is a computer having a function of supplying the image data IMG to the projector 10. In the example shown in FIG. 1, the terminal device 30 is a laptop computer. Note that the terminal device 30 is not limited to the laptop computer, but may be, for example, a desktop computer, a smartphone or a tablet terminal, a video player, a DVD (Digital Versatile Disk) player, a Blu-ray Disc player, a hard disk recorder, a television tuner, a set-top box for a CATV (Cable television), a video game machine, or the like.

### 1-2. Projector

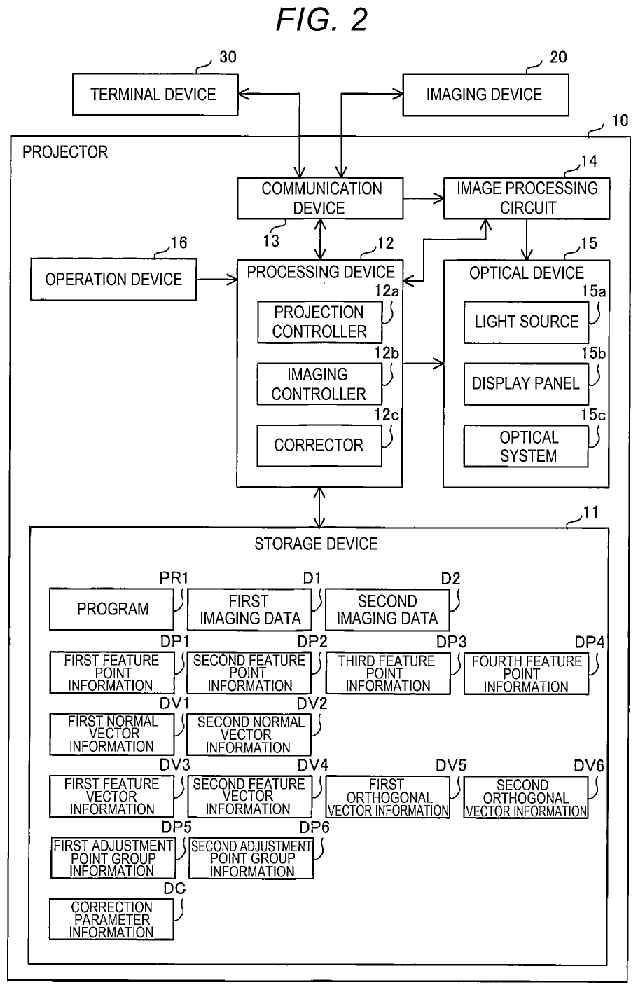

FIG. 2 is a block diagram of the projector 10 used in the system 100 according to the embodiment. FIG. 2 shows a coupling state of the imaging device 20 and the terminal device 30 with respect to the projector 10, in addition to the projector 10.

As shown in FIG. 2, the projector 10 includes a storage device 11, a processing device 12, a communication device 13, an image processing circuit 14, an optical device 15, and an operation device 16. These devices are communicably connected to one another. The processing device 12 is an example of “computer”.

The storage device 11 is a storage device that stores programs to be executed by the processing device 12 and data to be processed by the processing device 12. The storage device 11 includes, for example, a hard disk drive or a semiconductor memory. Part or all of the storage device 11 may be provided in a storage device, a server, or the like outside the projector 10.

The storage device 11 stores a program PR1, first imaging data D1, second imaging data D2, first feature point information DP1, second feature point information DP2, third feature point information DP3, fourth feature point information DP4, first normal vector information DV1, second normal vector information DV2, first feature vector information DV3, second feature vector information DV4, first orthogonal vector information DV5, second orthogonal vector information DV6, first adjustment point cloud information DP5, second adjustment point cloud information DP6, and correction parameter information DC.

The program PR1 is a program for correction of the projection image G projected onto the projection surface SC by the projector 10.

The first imaging data D1 is information indicating a first captured image GG1, which will be described later, acquired by imaging of the projection surface SC by the imaging device 20 in a first period, which will be described later. The second imaging data D2 is information indicating a second imaging image GG2, which will be described later, acquired by imaging of the projection surface SC by the imaging device 20 in a second period, which will be described later.

The first feature point information DP1 is information indicating a first feature point P1, which will be described later, as a feature point of the projection surface SC in the first captured image GG1 to be described later represented by the first imaging data D1. The second feature point information DP2 is information indicating a second feature point P2, which will be described later, as a feature point of the projection surface SC in the first captured image GG1 to be described later represented by the first imaging data D1. The third feature point information DP3 is information indicating a third feature point P3, which will be described later, as a feature point of the projection surface SC in the second captured image GG2 to be described later represented by the second imaging data D2. The fourth feature point information DP4 is information indicating a fourth feature point P4, which will be described later, as a feature point of the projection surface SC in the second captured image GG2 to be described later represented by the second imaging data D2.

The first normal vector information DV1 is information indicating a first normal vector Vn1, which will be described later. The second normal vector information DV2 is information indicating a second normal vector Vn2, which will be described later. The first feature vector information DV3 is information indicating a first feature vector Va1, which will be described later. The second feature vector information DV4 is information indicating a second feature vector Va2, which will be described later. The first orthogonal vector information DV5 is information indicating a first orthogonal vector Vb1, which will be described later. The second orthogonal vector information DV6 is information indicating a second orthogonal vector Vb2, which will be described later.

The first feature point information DP1 is information indicating positions of a plurality of adjustment points PR, which will be described later, set in the projection image G on the projection surface SC by coordinate values of a three-dimensional coordinate system in the first period to be described later and a period before correction within the second period to be described later. The second feature point information DP2 is information indicating positions of the plurality of adjustment points PR to be described later set in the projection image G on the projection surface SC by coordinate values of the three-dimensional coordinate system in a period after the correction within the second period to be described later. The correction parameter information DC is information indicating a parameter of an arithmetic expression for coordinate transformation for correcting the position of the projection image G with respect to the projection surface SC in the second period to be described later into the position of the projection image G with respect to the projection surface SC in the first period to be described later. By the coordinate transformation, the position indicated by the second feature point information DP2 is obtained from the position indicated by the first feature point information DP1.

The processing device 12 is a processing device having a function of controlling the individual units of the projector 10 and a function of processing various kinds of data. For example, the processing device 12 includes a processor such as a CPU (Central Processing Unit). Note that the processing device 12 may include a single processor or may include a plurality of processors. Part or all of the functions of the processing device 12 may be implemented by hardware such as a DSP (Digital Signal Processor), an ASIC (Application Specific Integrated Circuit), a PLD (Programmable Logic Device), or an FPGA (Field Programmable Gate Array). The processing device 12 may be integrated with at least a part of the image processing circuit 14.

The communication device 13 is a communication device that can communicate with various devices, and acquires image data IMG from the terminal device 30 or communicates with the imaging device 20. For example, the communication device 13 is a wired communication device such as a wired LAN (Local Area Network), USB (Universal Serial Bus), or HDMI (High Definition Multimedia Interface) device or a wireless communication device of an LPWA (Low Power Wide Area), wireless LAN including Wi-Fi, Bluetooth, or the like. Each of “HDMI”, “Wi-Fi”, and “Bluetooth” is a registered trademark.

The image processing circuit 14 is a circuit that performs necessary processing on the image data IMG from the communication device 13 and inputs the resultant data to the optical device 15. The image processing circuit 14 includes, for example, a frame memory (not shown), loads the image data IMG in the frame memory, appropriately executes various kinds of processing such as resolution conversion processing, resizing processing, and distortion correction processing on the data, and inputs the resultant data to the optical device 15. Here, for the various kinds of processing, the first feature point information DP1 or the second feature point information DP2 are appropriately used. Note that the image processing circuit 14 may execute processing such as OSD (On Screen Display) processing of generating image information for menu display, operation guidance, or the like and combining the information with the image data IMG as appropriate.

The optical device 15 is a device that projects image light on the projection surface SC. The optical device 15 includes a light source 15a, a display panel 15b, and an optical system 15c.

The light source 15a includes, for example, light sources such as halogen lamps, xenon lamps, ultra-high pressure mercury lamps, LEDs (light emitting diodes), or laser light sources, and emits red, green, and blue lights. The display panel 15b is a light modulator including three light modulation elements provided to correspond to red, green, and blue. The light modulation elements include, for example, transmissive liquid crystal panels, reflective liquid crystal panels, or DMDs (digital mirror devices) and modulate corresponding color lights to generate image lights of the individual colors. The image lights of the individual colors generated by the display panel 15b are combined by a light combining system to be a full color image light. The optical system 15c is a projection system including a projection lens that forms an image of the full color image light from the display panel 15b and projects the image on the projection surface SC, and the like.

The operation device 16 is a device that receives operations from a user. For example, the operation device 16 includes an operation panel and a remote control receiver (not shown). The operation panel is provided in an exterior housing of the projector 10 and outputs a signal according to an operation by the user. The remote control receiver receives an infrared signal from a remote controller (not shown), decodes the infrared signal, and outputs a signal according to the operation of the remote controller. The operation device 16 is provided as necessary or may be omitted.

In the above described projector 10, the processing device 12 functions as a projection controller 12a, an imaging controller 12b, and a corrector 12c by executing the program PR1 stored in the storage device 11. Therefore, the processing device 12 includes the projection controller 12a, the imaging controller 12b, and the corrector 12c.

The projection controller 12a controls operations of the image processing circuit 14 and the optical device 15. More specifically, the projection controller 12a controls the operation of the optical device 15 to cause the the optical device 15 to project the projection image G on the projection surface SC in each period of the first period and the second period to be described later.

The imaging controller 12b controls the operation of the imaging device 20. More specifically, the imaging controller 12b acquires the first imaging data D1 and the second imaging data D2 by causing the imaging device 20 to image the projection surface SC in each period of the first period and the second period to be described later.

The corrector 12c corrects the position of the projection image G with respect to the projection surface SC based on the first imaging data D1 and the second imaging data D2.

More specifically, the corrector 12c generates the first normal vector information DV1, the first feature point information DP1, and the second feature point information DP2 based on the first imaging data D1, then, generates the first feature vector information DV3 based on the first feature point information DP1 and the second feature point information DP2, and then, generates the first orthogonal vector information DV5 based on the first normal vector information DV1 and the first feature vector information DV3.

Further, the corrector 12c generates the second normal vector information DV2, the third feature point information DP3, and the fourth feature point information DP4 based on the second imaging data D2, then, generates the second feature vector information DV4 based on the third feature point information DP3 and the fourth feature point information DP4, and then, generates the second orthogonal vector information DV6 based on the second normal vector information DV2 and the second feature vector information DV4.

Furthermore, the corrector 12c generates the correction parameter information DC based on the first normal vector information DV1, the first feature vector information DV3, the first orthogonal vector information DV5, the second normal vector information DV2, the second feature vector information DV4, and the second orthogonal vector information DV6.

The corrector 12c generates the second feature point information DP2 based on the first feature point information DP1 and the correction parameter information DC.

### 1-3. Correction Method

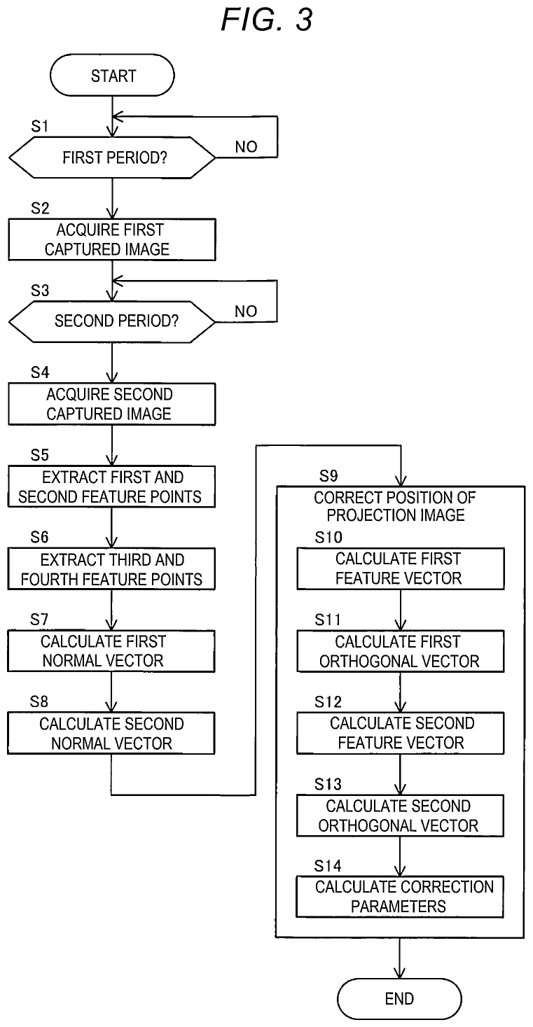

FIG. 3 is a flowchart showing a flow of a correction method according to the embodiment. The correction method is performed by the processing device 12 executing the program PR1 using the above described system 100. As shown in FIG. 3, the correction method includes steps S1 to S9, and corrects the projection image G projected on the projection surface SC by the projector 10. Here, step S9 includes steps S10 to S14.

Specifically, first, in step S1, whether the corrector 12c is in the first period is determined. This determination is made, for example, based on whether the corrector is at a predetermined time after the adjustment using the adjustment points PR to be described later is completed after the activation of the projector 10. Here, when the corrector is at the predetermined time, a determination that the corrector is in the first period is made. This step S1 is repeated until the determination that the corrector is in the first period is made (step S1: NO).

When the determination that the corrector is in the first period is made (step S1: YES), in step S2, the projection controller 12a controls the image processing circuit 14 and the optical device 15 to project a projection image G-1, which will be described later, onto the projection surface SC, then, the imaging controller 12b controls the imaging device 20 to capture the projection image G-1 to be described later and the projection surface SC, and thereby, acquires a first captured image GG1, which will be described later. Thus, the imaging controller 12b acquires the first imaging data D1.

After step S2, in step S3, whether the corrector 12c is in the second period is determined. This determination is made, for example, based on whether a predetermined time elapses after the completion of step S2, whether the optical device 15 is adjusted after the completion of step S2, or whether one or both of the position and the attitude of the projector 10 are changed by a predetermined degree or more after the completion of step S2. Here, when the predetermined time elapses after the completion of step S2, when the optical device 15 is adjusted after the completion of step S2, or when one or both of the position and the attitude of the projector 10 are changed by the predetermined degree or more after the completion of step S2, a determination that the corrector is in the second period is made. This step S3 is repeated until the determination that the corrector is in the second period is made (step S3: NO).

When the determination that the corrector is in the second period is made (step S3: YES), in step S4, the projection controller 12a controls the image processing circuit 14 and the optical device 15 to project a projection image G-2, which will be described later, onto the projection surface SC, then, the imaging controller 12b controls the imaging device 20 to capture the projection image G-2, which will be described later, and the projection surface SC, and thereby acquires a second captured image GG2, which will be described later. Thus, the imaging controller 12b acquires the second imaging data D2.

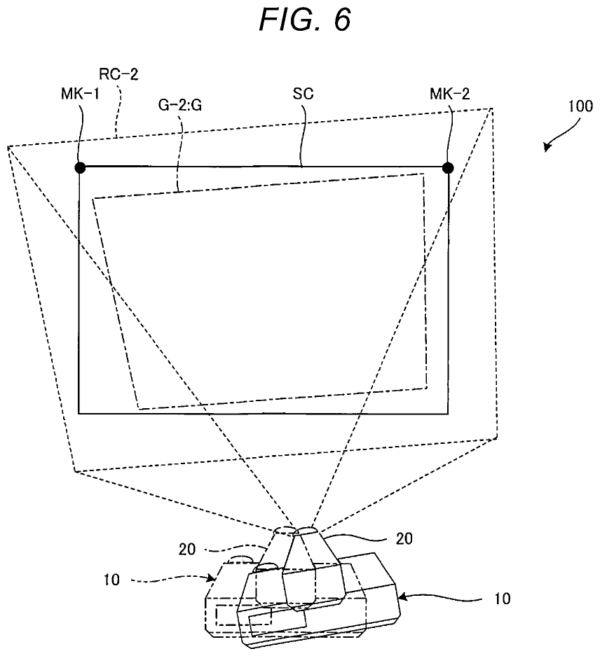

After step S4, in step S5, the corrector 12c extracts the first feature point P1 and the second feature point P2 to be described later. This extraction is performed based on the first captured image GG1 to be described later as will be described later in detail with reference to FIG. 6. The execution of step S5 may be before the above described step S4 as long as the execution is after step S2.

After step S5, in step S6, the corrector 12c extracts the third feature point P3 and the fourth feature point P4 to be described later. This extraction is performed based on the second captured image GG2 to be described later, as will be described later in detail with reference to FIG. 6. The execution of step S6 may be before the above described step S5 as long as the execution is after step S4.

After step S6, in step S7, the corrector 12c calculates the first normal vector Vn1 to be described later. This calculation is performed based on the first captured image GG1 to be described later, as will be described later in detail with reference to FIG. 6. The execution of step S7 may be before the above described step S6 as long as the execution is after step S2.

After step S7, in step S8, the corrector 12c calculates the second normal vector Vn2 to be described later. This calculation is performed based on the second captured image GG2 to be described later, as will be described later in detail with reference to FIG. 6. The execution of step S8 may be before the above described step S7 as long as the execution is after step S4.

After step S8, in step S9, the corrector 12c corrects the position of the projection image G. This correction is performed based on a set of the first feature point P1, the second feature point P2, and the first normal vector Vn1, and a set of the third feature point P3, the fourth feature point P4, and the second normal vector Vn2, as will be described later in detail with reference to FIG. 6.

Specifically, in step S10, the corrector 12c calculates a first feature vector Va1, which will be described later. This calculation is performed based on the first feature point P1 and the second feature point P2 as will be described later in detail with reference to FIG. 6.

After step S10, in step S11, the corrector 12c calculates a first orthogonal vector Vb1, which will be described later. This calculation is performed based on the first normal vector Vn1 and the first feature vector Va1 as will be described later in detail with reference to FIG. 6.

After step S11, in step S12, the corrector 12c calculates a second feature vector Va2, which will be described later. This calculation is performed based on the third feature point P3 and the fourth feature point P4 as will be described later in detail with reference to FIG. 6. The execution of step S12 may be before the above described step S11 as long as the execution is after step S6.

After step S12, in step S13, the corrector 12c calculates a second orthogonal vector Vb2, which will be described later. This calculation is performed based on the second normal vector Vn2 and the second feature vector Va2 as will be described later in detail with reference to FIG. 6. The execution of step S13 may be after step S12.

After step S13, in step S14, the corrector 12c calculates a correction parameter. Thereby, the correction parameter information DC indicating the correction parameter is obtained. This calculation is performed based on the first feature point P1, the second feature point P2, the first normal vector Vn1, the first feature vector Va1, the first orthogonal vector Vb1, the third feature point P3, the fourth feature point P4, the second normal vector Vn2, the second feature vector Va2, and the second orthogonal vector Vb2, as will be described later in detail with reference to FIG. 6.

In step S9, after the above described steps S10 to S14, the corrector 12c corrects the plurality of adjustment points PR to be described later using an arithmetic expression to which the correction parameter indicated by the correction parameter information DC is applied. Thus, the position of the projection image G is corrected.

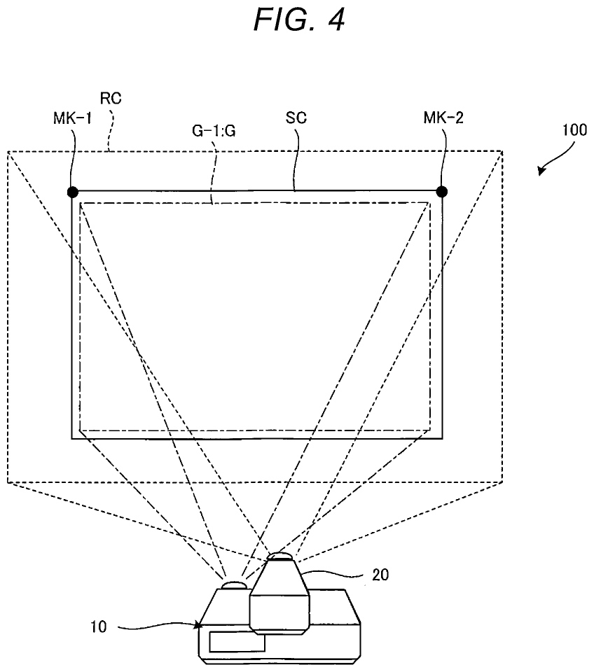

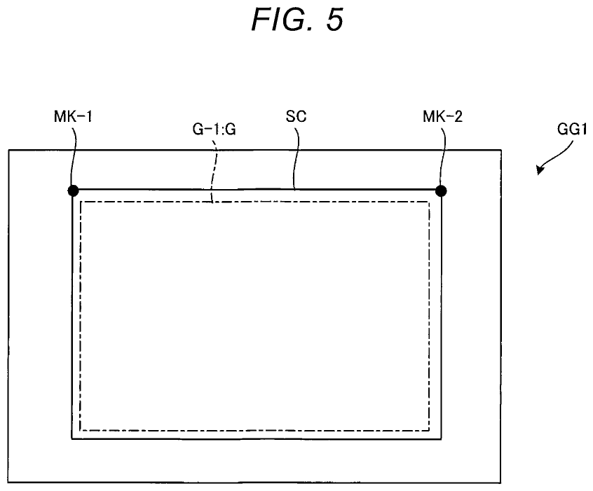

FIG. 4 shows acquisition of the first captured image GG1. FIG. 5 shows the first captured image GG1. FIG. 4 shows an example of a state in which the projection image G-1 as the projection image G in the first period is projected onto the projection surface SC.

The projection image G-1 has an outer shape adjusted using the plurality of adjustment points PR to be described later. In the example shown in FIG. 4, the outer shape of the projection image G-1 substantially coincides with the outer shape of the projection surface SC. The outer shape of the projection image G-1 in the first period is not limited to the example shown in FIG. 4, but may be optional.

In step S2, as shown in FIG. 4, the imaging controller 12b controls the imaging device 20 to capture the projection image G-1 and the projection surface SC in the first period. Thereby, step S2 executes acquisition of the first captured image GG1. As shown in FIG. 5, in the first captured image GG1 of the embodiment, the first physical marker MK-1 and the second physical marker MK-2 appear in addition to the projection image G-1 and the projection surface SC.

Here, the projection image G-1 is not particularly limited as long as the attitude of the projection surface SC as viewed from the projector 10 or the imaging device 20 can be measured based on the first captured image GG1. Preferably, the projection image may be an image with which the three-dimensional shape of the projection surface SC can be measured based on the first captured image GG1, for example, a structured-light pattern such as a phase shift pattern, a binary code pattern, a dot pattern, a rectangular pattern, a polygonal pattern, a checker pattern, a gray code pattern, or a random dot pattern.

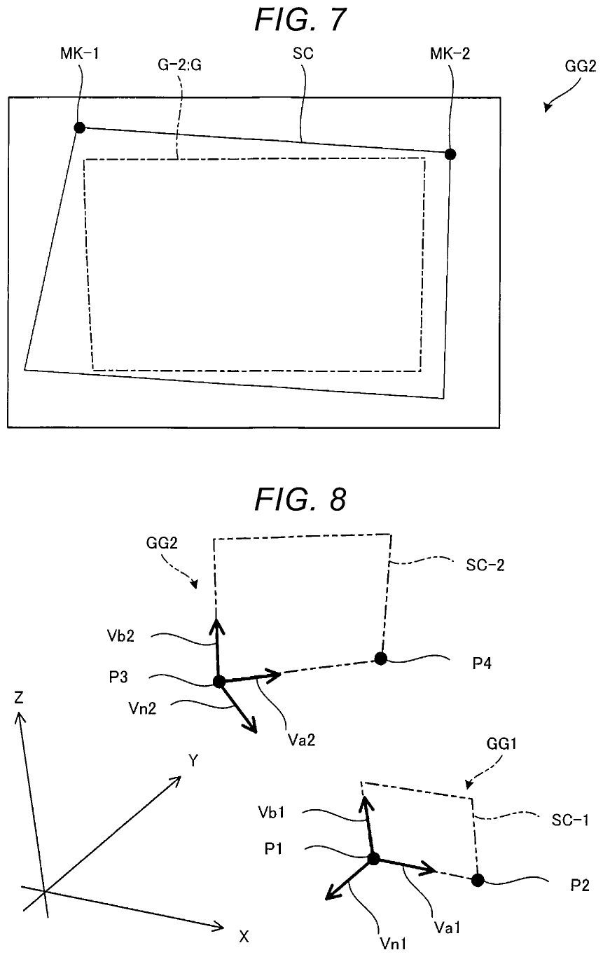

FIG. 6 shows acquisition of the second captured image GG2. FIG. 7 shows the second captured image GG2. FIG. 6 shows an example of a state in which the projection image G-2 as the projection image G in the second period is projected onto the projection surface SC.

The projection image G-2 has an outer shape different from that of the above described projection image G-2 on the projection surface SC with a change of one or both of the position and the attitude of the projector 10. The outer shape of the projection image G-2 in the second period is not limited to the example shown in FIG. 6, but may be optional.

In step S4, as shown in FIG. 6, the imaging controller 12b controls the imaging device 20 to capture the projection image G-2 and the projection surface SC in the second period after the first period. Thereby, step S4 executes acquisition of the second captured image GG2. As shown in FIG. 7, in the second captured image GG2 of the embodiment, the first physical marker MK-1 and the second physical marker MK-2 appear in addition to the projection image G-2 and the projection surface SC.

Here, the projection image G-2 is not particularly limited as long as the attitude of the projection surface SC as viewed from the projector 10 or the imaging device 20 can be measured based on the second captured image GG2. Preferably, the projection image may be an image with which the three-dimensional shape of the projection surface SC can be measured based on the second captured image GG2, for example, a structured-light pattern such as a phase shift pattern, a binary code pattern, a dot pattern, a rectangular pattern, a polygonal pattern, a checker pattern, a gray code pattern, or a random dot pattern. The projection image G-2 may be the same as or different from the projection image G-1.

FIG. 8 shows a relationship among the first feature point P1, the second feature point P2, the third feature point P3, and the fourth feature point P4. FIG. 8 shows the first feature point P1, the second feature point P2, the third feature point P3, and the fourth feature point P4 in a three-dimensional coordinate system as an orthogonal coordinate system of an X-axis, a Y-axis, and a Z-axis.

In step S5, the corrector 12c extracts the first feature point P1 and the second feature point P2 of the projection surface SC in the first captured image GG1. Similarly, in step S6, the corrector 12c extracts the third feature point P3 and the fourth feature point P4 of the projection surface SC in the second captured image GG2. The third feature point P3 is a point corresponding to the first feature point P1 of the projection surface SC in the second captured image GG2. The fourth feature point P4 is a point corresponding to the second feature point P2 of the projection surface SC in the second captured image GG2.

The extraction of these feature points is performed using, for example, a known image recognition technique by detecting predetermined two points of the projection surface SC as coordinate values in a two-dimensional imaging coordinate system of the imaging device 20. The detected coordinate values are transformed into coordinate values of a three-dimensional coordinate system using a predetermined transformation formula. The three-dimensional coordinate values A of the first feature point P1 are expressed by (Ax, Ay, Az), the three-dimensional coordinate values B of the second feature point P2 are expressed by (Bx, By, Bz), the three-dimensional coordinate values A′ of the third feature point P3 are expressed by (A′x, A′y, A′z), and the three-dimensional coordinate values B′ of the fourth feature point P4 are expressed by (B′x, B′y, B′z).

In the embodiment, in step S5, the first physical marker MK-1 and the second physical marker MK-2 are detected as the predetermined two points of the projection surface SC. Similarly, in step S6, the first physical marker MK-1 and the second physical marker MK-2 are detected as the predetermined two points of the projection surface SC. Here, each of the first feature point P1 and the third feature point P3 is extracted based on the reflected light from the first physical marker MK-1. On the other hand, each of the second feature point P2 and the fourth feature point P4 is extracted based on the reflected light from the second physical marker MK-2. The physical markers are used in this manner, and thereby, the accuracy of extraction of the feature points can be increased regardless of the contrast difference between the projection surface SC and the background or the like.

In step S7, the corrector 12c executes calculation of the first normal vector Vn1. The first normal vector Vn1 is a normal vector of the projection surface SC in the first period. In step S7, the corrector 12c measures the three-dimensional shape of the projection surface SC based on the first captured image GG1, and calculates the first normal vector Vn1 based on the measurement result. Here, the measurement result of the three-dimensional shape is expressed by, for example, three-dimensional planar parameters (a, b, c) of the projection surface SC. The first normal vector Vn1 is obtained by normalization of the normal vector (a, b, c) to the length “1”. Accordingly, in the coordinate values (X, Y, Z) of the three-dimensional coordinate system, a, b, and c satisfy the relationship ax+bY+cZ=1.

Similarly, in step S8, the corrector 12c executes calculation of the second normal vector Vn2. The second normal vector Vn2 is a normal vector of the projection surface SC in the second period. In step S8, the corrector 12c measures the three-dimensional shape of the projection surface SC based on the second captured image GG2, and calculates the second normal vector Vn2 based on the measurement result. Here, the measurement result of the three-dimensional shape is expressed by, for example, three-dimensional planar parameters (a′, b′, c′) of the projection surface SC. The second normal vector Vn2 is obtained by normalization of the normal vector (a′, b′, c′) to the length “1”. Accordingly, in the coordinate values (X, Y, Z) of the three-dimensional coordinate system, a′, b′, and c′ satisfy the relationship of a′x+b′Y+c′Z=1.

In step S10, the corrector 12c executes calculation of the first feature vector Va1. The first feature vector Va1 is a vector from the first feature point P1 toward the second feature point P2. The calculation of the first feature vector Va1 is performed based on the first feature point P1 and the second feature point P2. For example, the first feature vector Va1 is obtained by normalization of a vector, which is obtained by subtraction of the three-dimensional coordinate values A of the first feature point P1 from the three-dimensional coordinate values B of the second feature point P2, to the length “1”.

Similarly, in step S12, the corrector 12c executes calculation of the second feature vector Va2. The second feature vector Va2 is a vector from the third feature point P3 toward the fourth feature point P4. The calculation of the second feature vector Va2 is performed based on the third feature point P3 and the fourth feature point P4. For example, the second feature vector Va2 is obtained by normalization of a vector, which is obtained by subtraction of the three-dimensional coordinate values A′ of the third feature point P3 from the three-dimensional coordinate values B′ of the fourth feature point P4, to the length “1”.

In step S11, the corrector 12c executes calculation of the first orthogonal vector Vb1. The first orthogonal vector Vb1 is a vector orthogonal to both the first normal vector Vn1 and the first feature vector Va1. The calculation of the first orthogonal vector Vb1 is performed based on the first normal vector Vn1 and the first feature vector Va1. For example, the first orthogonal vector Vb1 is obtained by the cross product of the first normal vector Vn1 and the first feature vector Va1. Here, the first orthogonal vector Vb1 is a vector normalized to the length “1”.

Similarly, in step S13, the corrector 12c executes calculation of the second orthogonal vector Vb2. The second orthogonal vector Vb2 is a vector orthogonal to both the second normal vector Vn2 and the second feature vector Va2. The calculation of the second orthogonal vector Vb2 is performed based on the second normal vector Vn2 and the second feature vector Va2. For example, the second orthogonal vector Vb2 is obtained by the cross product of the second normal vector Vn2 and the second feature vector Va2. Here, the second orthogonal vector Vb2 is a vector normalized to the length “1”.

In step S14, the corrector 12c calculates R and s in the following arithmetic expression as the correction parameters.

$${P}^{′} m = sR ( Pm - A ) + {A}^{′}$$

Here, R is a 3×3 rotation matrix in which the first normal vector Vn1, the first feature vector Va1, and the first orthogonal vector Vb1 which are orthogonal to one other become the second normal vector Vn2, the second feature vector Va2, and the second orthogonal vector Vb2, respectively.

When the distance between the first feature point P1 and the second feature point P2 is c and the distance between the third feature point P3 and the fourth feature point P4 is c′, s is a ratio c/c′ of the distances.

Pm are three-dimensional coordinate values of the m-th pixel of N pixels in the projection image G-1 on the projection surface SC. P′m are three-dimensional coordinate values of the m-th pixel of N pixels in the projection image G-2 on the projection surface SC. N is a natural number of three or more, and m is a natural number of one or more and N or less. The three-dimensional coordinate values of the N pixels are, for example, three-dimensional coordinate values of the adjustment points PR to be described later.

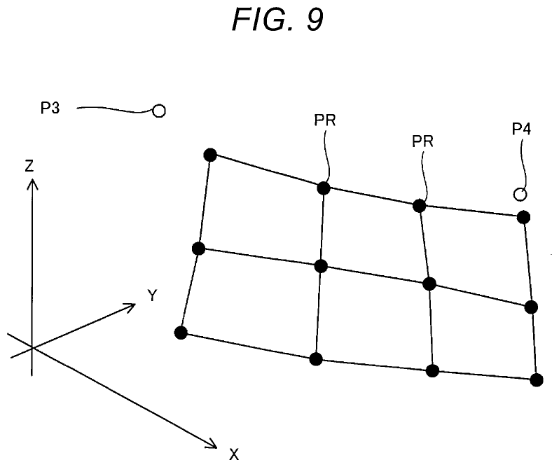

FIG. 9 shows correction of the position of the projection image G. FIG. 9 shows the third feature point P3, the fourth feature point P4, and the plurality of adjustment points PR before correction in the three-dimensional coordinate system.

Before the first period, adjustment of the projection image G with respect to the projection surface SC is performed using the plurality of adjustment points PR. The plurality of adjustment points PR correspond to the plurality of pixels in the projection image G.

The individual adjustment points PR can be moved by operation by the user as necessary. When two or more adjustment points PR selected by the user of the plurality of adjustment points PR are moved, with changes of the distances between the plurality of adjustment points PR, portions of the projection image G corresponding to the distances are deformed. Thereby, the shape of the projection image G can be adjusted to conform to the shape of the projection surface SC. The adjustment is performed before step S1, and thereby, the first feature point information DP1 is obtained.

In the period before correction of the second period, the projection image G-2 based on the coordinate values indicated by the first feature point information DP1 is projected onto the projection surface SC and, as shown in FIG. 9, the plurality of adjustment points PR are deviated from desired positions with respect to the third feature point P3 and the fourth feature point P4.

In step S9, the corrector 12c corrects the position of the projection image G with respect to the projection surface SC using the above described arithmetic expression. Specifically, after step S14, the corrector 12c calculates the three-dimensional coordinate values indicated by the second feature point information DP2 as the three-dimensional coordinate values P′m using the above described calculation expression, with the three-dimensional coordinate values indicated by the first feature point information DP1 as the three-dimensional coordinate values Pm. The projection image G is projected using the second feature point information DP2, and thereby, the position of the projection image G-2 with respect to the projection surface SC in the second period is corrected to the position of the projection image G-1 with respect to the projection surface SC in the first period.

As described above, in step S9, the corrector 12c executes correction of the position of the projection image G with respect to the projection surface SC in the second period to the position of the projection image G with respect to the projection surface SC in the first period, based on the set of the first feature point P1, the second feature point P2, and the first normal vector Vn1 and the set of the third feature point P3, the fourth feature point P4, and the second normal vector Vn2.

Here, as described above, in step S9, the position of the projection image G-2 with respect to the projection surface SC in the second period is corrected to the position of the projection image G-1 with respect to the projection surface SC in the first period, based on the difference between the first normal vector Vn1 and the second normal vector Vn2, the difference between the first feature vector Va1 and the second feature vector Va2, and the difference between the first orthogonal vector Vb1 and the second orthogonal vector Vb2. Thus, the position of the projection image G can be corrected after the matrix R for correction of the projection image G is calculated by a simpler calculation.

As described above, each of the first normal vector Vn1, the second normal vector Vn2, the first feature vector Va1, the second feature vector Va2, the first orthogonal vector Vb1, and the second orthogonal vector Vb2 is a normalized vector obtained by normalization of the magnitude to “1”. Thus, the aspect ratio and the like can be maintained at the time of restoration.

In the above described correction method, a matrix for correction of a projection image can be calculated based on two feature points in each captured image. Thereby, the complexity of the matrix calculation can be reduced.

In the embodiment, the physical markers are used for detection of the feature points of the projection surface SC, and the number of physical markers disposed by the user can be reduced compared to the configuration in JP-A-2022-092169. Thereby, the complexity of the operation by the user can be reduced.

### 2. MODIFIED EXAMPLES

The individual embodiments exemplified above can be variously modified. Specific modified configurations that can be applied to the above described embodiments will be are exemplified below. Two or more configurations optionally selected from the following exemplifications can be combined as appropriate as long as the configurations are mutually consistent.

### 2-1. Modified Example 1

In the above described embodiments, the configuration in which the processing device 12 of the projector 10 executes the program PR1 is exemplified, however, the present disclosure is not limited to the configuration. For example, a processing device of a computer or the terminal device 30 communicably connected to the projector 10 and the imaging device 20 may execute the program PR1.

### 2-2. Modified Example 2

In the above described embodiment, the configuration in which the first orthogonal vector Vb1 and the second orthogonal vector Vb2 are used for correction of the projection position of the projection image G is exemplified, however, the present disclosure is not limited to the configuration. For example, a vector not orthogonal to, but intersecting with the first normal vector Vn1 and the first feature vector Va1 at predetermined angles may be used in place of the first orthogonal vector Vb1 and a vector not orthogonal to, but intersecting with the second normal vector Vn2 and the second feature vector Va2 at the predetermined angles may be used in place of the second orthogonal vector Vb2.

### 3. APPENDIXES

The present disclosure will be summarized below as Appendixes.

(Appendix 1) A first configuration as a preferred example of the correction method of the present disclosure is a correction method for correcting a projection image projected on a planar surface by a projector, including acquiring a first captured image obtained by imaging of the projection image and the planar surface by an imaging device in a first period, acquiring a second captured image obtained by imaging of the projection image and the planar surface by the imaging device in a second period after the first period, extracting a first feature point and a second feature point of the planar surface in the first captured image, extracting a third feature point corresponding to the first feature point and a fourth feature point corresponding to the second feature point of the planar surface in the second captured image, calculating a first normal vector as a normal vector of the planar surface in the first period, calculating a second normal vector as a normal vector of the planar surface in the second period, and correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.

In the above described configuration, a matrix for correction of a projection image based on two feature points in each captured image can be calculated. Thereby, the complexity of the matrix calculation can be reduced.

(Appendix 2) A second configuration as a preferred example of the first configuration includes calculating a first feature vector as a vector from the first feature point toward the second feature point, calculating a first orthogonal vector orthogonal to both the first normal vector and the first feature vector, calculating a second feature vector as a vector from the third feature point toward the fourth feature point, and calculating a second orthogonal vector orthogonal to both the second normal vector and the second feature vector, wherein the position of the projection image with respect to the planar surface in the second period is corrected to the position of the projection image with respect to the planar surface in the first period based on a difference between the first normal vector and the second normal vector, a difference between the first feature vector and the second feature vector, and a difference between the first orthogonal vector and the second orthogonal vector. In the above described configuration, the matrix for correction of the projection image can be calculated by a simpler calculation.

(Appendix 3) In a third configuration as a preferred example of the first configuration or the second configuration, each of the first normal vector, the second normal vector, the first feature vector, the second feature vector, the first orthogonal vector, and the second orthogonal vector is a normalized vector obtained by normalization of magnitude to “1”. In the above described configuration, the aspect ratio and the like can be maintained at the time of restoration.

(Appendix 4) In a fourth configuration as a preferred example of any one of the first to third configurations, the first feature point and the third feature point are extracted based on reflected light from a first physical marker detachably disposed on the planar surface, and the second feature point and the fourth feature point are extracted based on reflected light from a second physical marker detachably disposed on the planar surface. In the above described configuration, the number of physical markers disposed by the user can be reduced. Thereby, the complexity of the operation by the user can be reduced.

(Appendix 5) A fifth configuration as a preferred example of the system of the present disclosure is a system including a projector projecting a projection image onto a planar surface, and an imaging device imaging the planar surface and the projection image, wherein the projector executes acquiring a first captured image obtained by imaging of the projection image and the planar surface by the imaging device in a first period and a second captured image obtained by imaging of the projection image and the planar surface by the imaging device in a second period after the first period, extracting a first feature point and a second feature point of the planar surface in the first captured image, extracting a third feature point corresponding to the first feature point and a fourth feature point corresponding to the second feature point of the planar surface in the second captured image, calculating a first normal vector as a normal vector of the planar surface in the first period, calculating a second normal vector as a normal vector of the planar surface in the second period, and correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.

In the above described configuration, a matrix for correction of a projection image based on two feature points in each captured image can be calculated. Thereby, the complexity of the matrix calculation can be reduced.

(Appendix 6) A sixth configuration as a preferred example of the non-transitory computer-readable storage medium storing a program of the present disclosure is a non-transitory computer-readable storage medium storing a program for correcting a projection image projected onto a planar surface by a projector, the program causing a computer to execute acquiring a first captured image obtained by imaging of the projection image and the planar surface by an imaging device in a first period and a second captured image obtained by imaging of the projection image and the planar surface by the imaging device in a second period after the first period, extracting a first feature point and a second feature point of the planar surface in the first captured image, extracting a third feature point corresponding to the first feature point and a fourth feature point corresponding to the second feature point of the planar surface in the second captured image, calculating a first normal vector as a normal vector of the planar surface in the first period, calculating a second normal vector as a normal vector of the planar surface in the second period, and correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.

In the above described configuration, a matrix for correction of a projection image based on two feature points in each captured image can be calculated. Thereby, the complexity of the matrix calculation can be reduced.

What is claimed is:

1. A correction method for correcting a projection image projected on a planar surface by a projector, comprising:
acquiring a first captured image obtained by imaging of the projection image and the planar surface by an imaging device in a first period;
acquiring a second captured image obtained by imaging of the projection image and the planar surface by the imaging device in a second period after the first period;
extracting a first feature point and a second feature point of the planar surface in the first captured image;
extracting a third feature point corresponding to the first feature point and a fourth feature point corresponding to the second feature point of the planar surface in the second captured image;
calculating a first normal vector as a normal vector of the planar surface in the first period;
calculating a second normal vector as a normal vector of the planar surface in the second period; and
correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.

2. The correction method according to claim 1, further comprising:
calculating a first feature vector as a vector from the first feature point toward the second feature point;
calculating a first orthogonal vector orthogonal to both the first normal vector and the first feature vector;
calculating a second feature vector as a vector from the third feature point toward the fourth feature point; and
calculating a second orthogonal vector orthogonal to both the second normal vector and the second feature vector, wherein
the position of the projection image with respect to the planar surface in the second period is corrected to the position of the projection image with respect to the planar surface in the first period based on a difference between the first normal vector and the second normal vector, a difference between the first feature vector and the second feature vector, and a difference between the first orthogonal vector and the second orthogonal vector.

3. The correction method according to claim 2, wherein
each of the first normal vector, the second normal vector, the first feature vector, the second feature vector, the first orthogonal vector, and the second orthogonal vector is a normalized vector obtained by normalization of magnitude to “1”.

4. The correction method according to claim 1, wherein
the first feature point and the third feature point are extracted based on reflected light from a first physical marker detachably disposed on the planar surface, and
the second feature point and the fourth feature point are extracted based on reflected light from a second physical marker detachably disposed on the planar surface.

5. A system comprising:
a projector projecting a projection image onto a planar surface; and
an imaging device imaging the planar surface and the projection image, wherein
the projector executes
acquiring a first captured image obtained by imaging of the projection image and the planar surface by the imaging device in a first period,
acquiring a second captured image obtained by imaging of the projection image and the planar surface by the imaging device in a second period after the first period,
extracting a first feature point and a second feature point of the planar surface in the first captured image,
extracting a third feature point corresponding to the first feature point and a fourth feature point corresponding to the second feature point of the planar surface in the second captured image,
calculating a first normal vector as a normal vector of the planar surface in the first period,
calculating a second normal vector as a normal vector of the planar surface in the second period, and
correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.

6. A non-transitory computer-readable storage medium storing a program for correcting a projection image projected onto a planar surface by a projector, the program causing a computer to execute:
acquiring a first captured image obtained by imaging of the projection image and the planar surface by an imaging device in a first period;
acquiring a second captured image obtained by imaging of the projection image and the planar surface by the imaging device in a second period after the first period;
extracting a first feature point and a second feature point of the planar surface in the first captured image;
extracting a third feature point corresponding to the first feature point and a fourth feature point corresponding to the second feature point of the planar surface in the second captured image;
calculating a first normal vector as a normal vector of the planar surface in the first period;
calculating a second normal vector as a normal vector of the planar surface in the second period; and
correcting a position of the projection image with respect to the planar surface in the second period to a position of the projection image with respect to the planar surface in the first period based on a set of the first feature point, the second feature point, and the first normal vector and a set of the third feature point, the fourth feature point, and the second normal vector.
